(19) United States
(12) Patent Application Publication
(10) Pub. No.: US 2022/0398640 A1
(43) Pub. Date: Dec. 15, 2022

(54) Photography Composition Service

(71) Applicant: AT&T Intellectual Property I, L.P., Atlanta, GA (US)

(72) Inventor: Daniel Connor Sloat, Lancaster, TX (US)

(73) Assignee: AT&T Intellectual Property I, L.P., Atlanta, GA (US)

(21) Appl. No.: 17/345,085

(22) Filed: Jun. 11, 2021

(51) Int. Cl. G06Q 30/06; G06Q 20/08

(52) U.S. Cl. CPC G06Q 30/0611; G06Q 30/0639; G06Q 20/085

(57) ABSTRACT

The concepts and technologies disclosed herein are a photography composition service. According to one aspect disclosed herein, a requester device can create, on behalf of a requester user, a request for a photograph to be captured by a provider user via a provider device. The request can specify a composition template to be used by the provider user to capture the photograph. The request can further specify an offer to the provider user in compensation for capturing the photograph. The requester device can provide the request to the provider device. The requester device can determine if the offer was accepted. In response to determining that the offer was accepted, the requester device can notify the requester user that the offer was accepted. The requester device can receive the photograph and fulfill the offer to the provider user in compensation for the provider user capturing the photograph.

### BACKGROUND

In 2019, 50 billion photographs were taken on smartphones, and according to some market research, approximately 90% of these interactions resulted in disappointment with the photograph or worse. While requesting a favor from a stranger to take a photograph has become a universal custom, it most often leads to awkward interactions, emotional rejection, and wasted time because it can be difficult to explain in words how the photograph should look. Other common, more quantifiable risks during this interaction involve damage to the smartphone (e.g., accidental dropping), theft, as well as virus transmission.

Photography composition applications currently exist, but these applications require handing over a smartphone to a stranger, so potential disappointment with the photograph is the only problem addressed. Some individuals may hire professional photographers for their expertise, but in addition to being prohibitively expensive, coordinating an on-demand photography service may be difficult or impossible.

### SUMMARY

Concepts and technologies disclosed herein are directed to a photography composition service. According to one aspect disclosed herein, a requester device can create, on behalf of a requester user, a request for a photograph to be captured by a provider user via a provider device. The request can specify a composition template to be used by the provider user to capture the photograph. The request can further specify an offer to the provider user in compensation for capturing the photograph. The requester device can provide the request to the provider device. The requester device can determine if the offer was accepted. In response to determining that the offer was accepted, the requester device can notify the requester user that the offer was accepted. The requester device can receive the photograph and fulfill the offer to the provider user in compensation for the provider user capturing the photograph.

In some embodiments, the request can specify a plurality of parameters. The parameters can include a location parameter and the composition template. The composition template can include a pre-built composition template or a custom composition template created by the requester user. The location parameter can include a current location of the requester device or a custom location. The location parameter can include a photograph opportunity location, such as a landmark or user recommended location.

In some embodiments, the requester device can provide the request to the provider device by sending the request to the provider device. In addition or alternatively, the requester device can provide the request to the provider device by sending the request to a marketplace through which the provider user can accept the offer.

In some embodiments, the requester device can fulfill the offer to the provider user in compensation for the provider user capturing the photograph, which can include initiating monetary payment to be sent to an account associated the provider user. In some embodiments, payment can be arranged via one or more payment platforms (e.g., a mobile payment service such as VENMO, a bank or credit union, a credit card processor, or other financial entity) to complete the transaction. The exchange of physical currency is also contemplated. In some embodiments, the photograph can be transferred and/or stored, and/or payment (i.e., honoring the offer) can be completed on a distributed ledger such as a blockchain. The distributed ledger can implement smart contracts to ensure the requester user and the provider user perform tasks required of them for a successful transaction. In some embodiments, the photograph can be provided as or part of a non-fungible token (“NFT”) on the distributed ledger.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

Other systems, methods, and/or computer program products according to embodiments will be or become apparent to one with skill in the art upon review of the following drawings and detailed description. It is intended that all such additional systems, methods, and/or computer program products be included within this description, be within the scope of this disclosure.

### BRIEF DESCRIPTION OF THE DRAWINGS

FIG. 1 is a block diagram illustrating aspects of an illustrative operating environment for various concepts and technologies disclosed herein.

FIGS. 2A-2I are user interface diagrams illustrating aspects of a requester application user interface, according to illustrative embodiments of the concepts and technologies disclosed herein.

FIGS. 3A-3I are user interface diagrams illustrating aspects of a provider application user interface, according to illustrative embodiments of the concepts and technologies disclosed herein.

FIGS. 4A-4B are flow diagrams illustrating aspects of a method for utilizing a photography composition service from the perspective of a requester device, according to an illustrative embodiment of the concepts and technologies disclosed herein.

FIG. 5 is a flow diagram illustrating aspects of a method for utilizing a photography composition service from the perspective of a provider device, according to an illustrative embodiment of the concepts and technologies disclosed herein.

FIG. 6 is a block diagram illustrating an example computer system capable of implementing aspects of the concepts and technologies disclosed herein.

FIG. 7 is a block diagram illustrating an example mobile device capable of implementing aspects of the concepts and technologies disclosed herein.

FIG. 8 is a block diagram illustrating a virtualized cloud architecture capable of implementing aspects of the concepts and technologies disclosed herein.

FIG. 9 is a block diagram illustrating an example network capable of implementing aspects of the concepts and technologies disclosed herein.

FIG. 10 is a block diagram illustrating an example machine learning system capable of implementing aspects of the concepts and technologies disclosed herein.

### DETAILED DESCRIPTION

The concepts and technologies disclosed herein are directed to a photography composition service. More particularly, the concepts and technologies disclosed herein provide an application through which a user can submit a request for a photography composition service. A user (i.e., requester user) can select a pre-built composition template or create a custom composition template and offer what they think is a fair price for one or more photographs that utilize the composition template. Other application users (i.e., provider users) can be notified of the request and decide whether the offer is worth their time according to free market dynamics. Upon acceptance of the offer, the provider user(s) and the requester user can be connected via their respective devices (e.g., smartphone, tablet, or other mobile device). After the provider user captures the photograph and the requester user approves of the photograph, a digital payment in the amount of the offer can be transferred to an account associated with the provider user.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

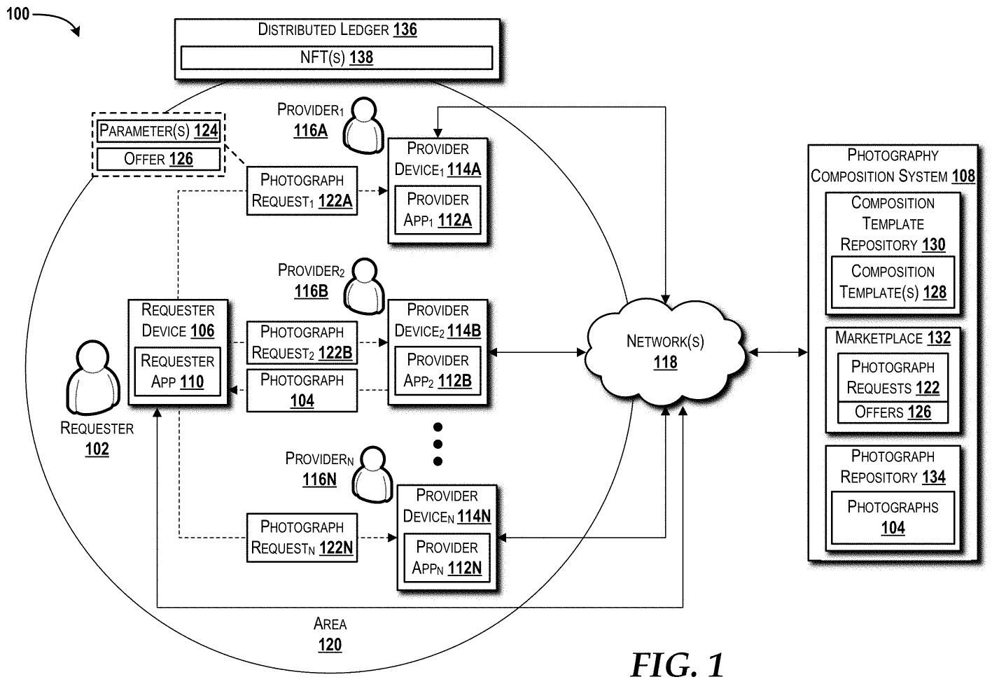

Turning now to FIG. 1, an operating environment 100 in which embodiments of the concepts and technologies disclosed herein will be described. The operating environment 100 includes a requester user (hereinafter “requester”) 102 who desires to obtain one or more photographs 104 via a requester device 106 (e.g., a smartphone, tablet, or other mobile device). The photograph 104 can be of any subject, including any person, place, thing, or combination of photograph subjects. The concepts and technologies disclosed herein find particular application in scenarios where the requester 102 desires the photograph 104 to be of themselves alone or in a group with one or more other individuals, but does not want to or is unable to obtain the photograph 104 for some reason. Typically, the requester 102 would have to request a favor from a stranger nearby and ask them to take the photograph 104 with the requester device 106. This most often leads to awkward interactions, emotional rejection, and wasted time because it can be difficult for the requester 102 to explain in words how the photograph 104 should look. Other common, more quantifiable risks during this interaction may involve damage to the requester device 106 (e.g., accidental dropping), theft, as well as virus transmission or other malicious activity. The concepts and technologies disclosed herein overcome these challenges through a photography composition service.

The photography composition service can be provided, at least in part, via a photography composition system 108, a photography composition service requester application (hereinafter “requester application”) 110 executed by the requester device 106, and one or more photography composition service provider applications (hereinafter “provider application” or “provider applications”) 112A-112N executed by one or more provider devices (hereinafter “provider device” or “provider devices”) 114A-114N (e.g., smartphone, tablet, or other mobile device with a camera component) associated with one or more provider users (hereinafter “provider” or “providers”) 116A-116N. In some embodiments, the requester application 110 and/or the provider applications 112A-112N are client applications for the photography composition system 108. In other embodiments, the requester application 110 and/or the provider applications 112A-112N can provide at least a portion of the functionality of the photography composition system 108. Accordingly, any description of functionality being performed by the photography composition system 108 can be performed either locally by the requester device 106 via execution of the requester application 110 and/or by the provider device(s) 114 via execution of the provider application(s) 112, or remotely by the photography composition system 108 at the request of the requester device 106 and/or the provider device(s) 114.

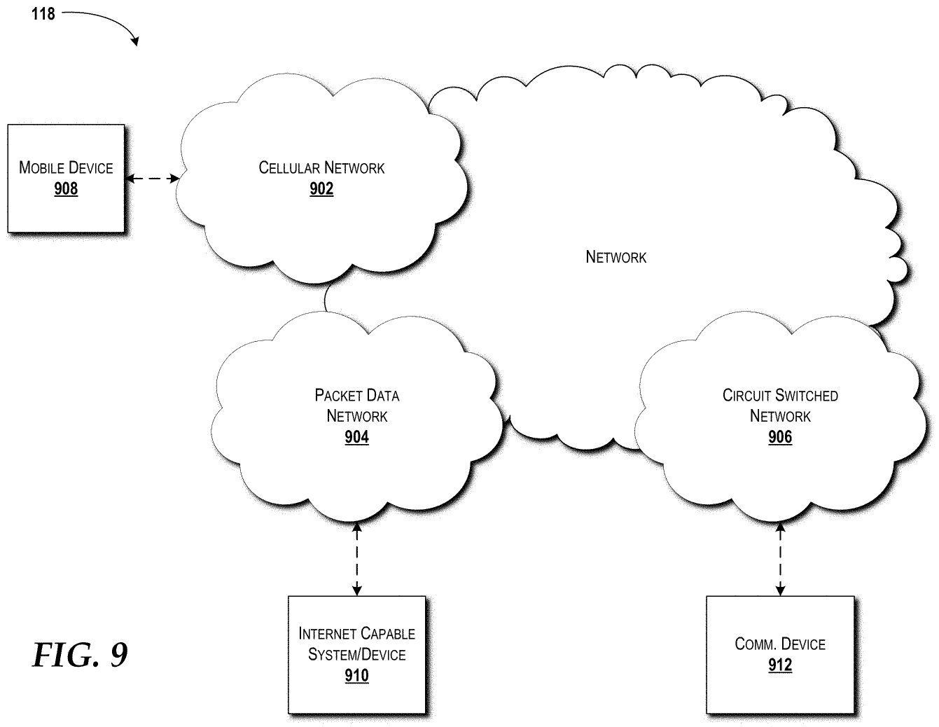

The requester device 106, the provider devices 114A-114N, and the photography composition system 108 can communicate via one or more networks 118. The network(s) 118 may include one or more wireless networks such as, but not limited to, a Wireless Local Area Network (“WLAN”) such as a WI-FI network, a Wireless Wide Area Network (“WWAN”), a Wireless Personal Area Network (“WPAN”) such as BLUETOOTH, a Wireless Metropolitan Area Network (“WMAN”) such a WiMAX network, adhoc networks, peer-to-peer networks, any combination thereof, and the like. The networks 118 also may include one or more wired networks, including backhaul network(s) implemented, for example, using cable and/or fiber in support of one or more wireless networks. Data link cables for connecting two or more devices, such as the requester device 106 and the provider device 114 are also contemplated. For purposes of explanation, and not limitation, the network 118 will be described as a WWAN implemented via one or more wireless technologies that facilitate communications among the requester device 106, the photography composition system 108, and the provider devices 114A-114N. It is contemplated that the requester device 106 and the provider devices 114A-114N may communicate with each other via one network (e.g., WLAN or BLUETOOTH) and with the photography composition system 108 via another network (e.g., WWAN). An example network 118 is described herein with reference to FIG. 9.

In the illustrated example, the requester 102 is positioned in an area 120 in which the requester 102 desires the photograph 104 to be taken. The area 120 can be any size or shape, but for purposes of explanation, the area 120 will be defined as a circle having a radius of approximately 50 feet, which is sufficient to encompass the providers 116A-116N and their respective provider devices 114A-114N. The requester 102 can utilize the requester application 110 to create photograph requests (hereinafter “photograph request” or “photograph requests”) 122A-122N. The requester 102 can define, in the photograph requests 122, one or more parameter(s) 124 and an offer 126.

The parameters 124 may include a location of where the photograph 104 is to be taken. The location may be a current location of the requester 102 as determined, for example, via a Global Positioning System (“GPS”), cellular triangulation, or other location determining technique used by the requester device 106. The location may be a custom location defined via latitude/longitude coordinates, address, or well-known named location (e.g., a national monument). The location may also be defined via a photograph opportunity. The photo opportunity locations may be provided by the photography composition system 108, individuals (e.g., through the requester application 110 and/or social media), by a municipality, by a company, or by any other entity. In some embodiments, the photo opportunities change based upon time of day, date, weather, and/or other variable(s).

The parameters 124 may include a selection from one or more pre-built composition templates 128 that can define, at least in part, a desired composition of the photograph 104. The pre-built composition template(s) 128 can be stored by the photography composition system 108 in a composition template repository 130. The elements of composition that can be utilized to define, at least in part, the pre-built composition template 128 can include patterns, texture, symmetry, asymmetry, depth of field, lines, curves, frames, contrast, color, viewpoint, depth, negative space, filled space, foreground, background, visual tension, shapes, or any combination thereof. It is contemplated that one or more other parameters 124 may influence which pre-built composition templates 128 are available for selection. For example, a pre-built composition template 128 may be defined for a particular photo opportunity location and may only be available when the requester device 106 is located within the area 120 that includes the photo opportunity location. In addition to or as an alternative to the pre-built composition template 128 being particular to a photo opportunity location or other location, the pre-built composition template 128 may be generic such as to provide a basic composition for portraits, landscapes, or other photograph types.

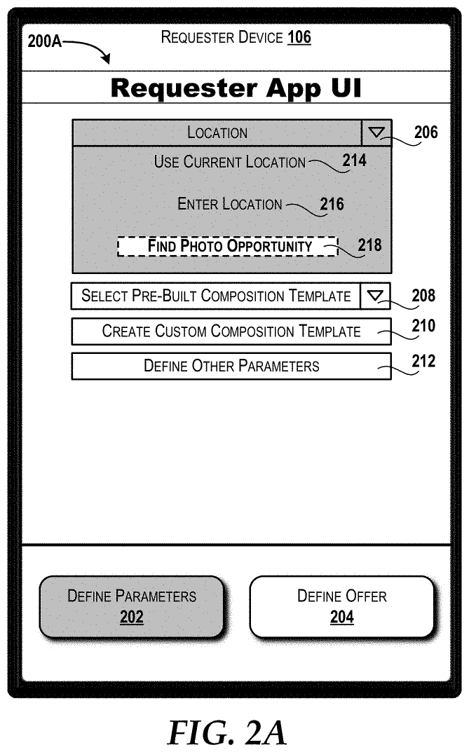

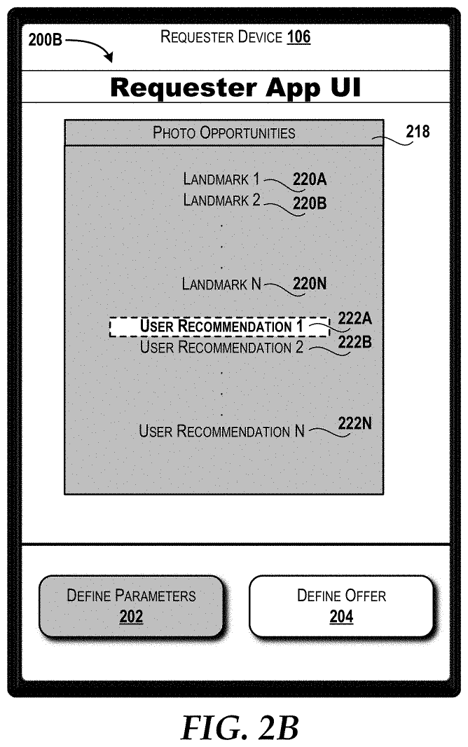

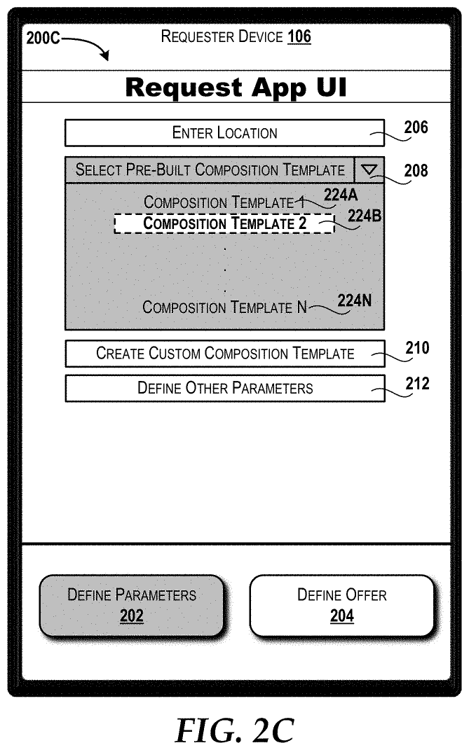

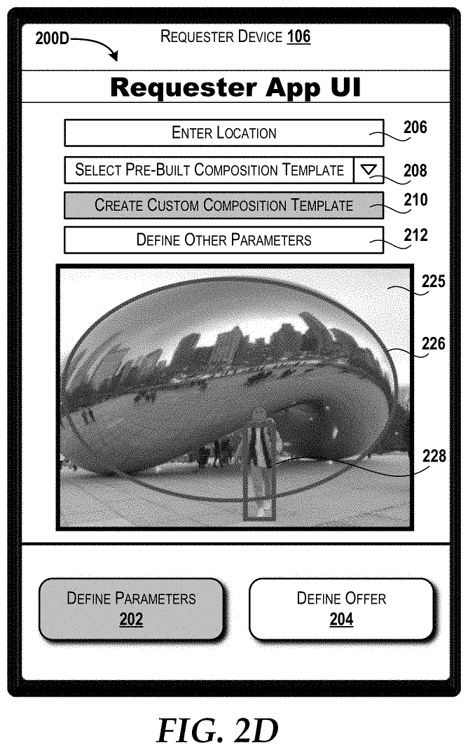

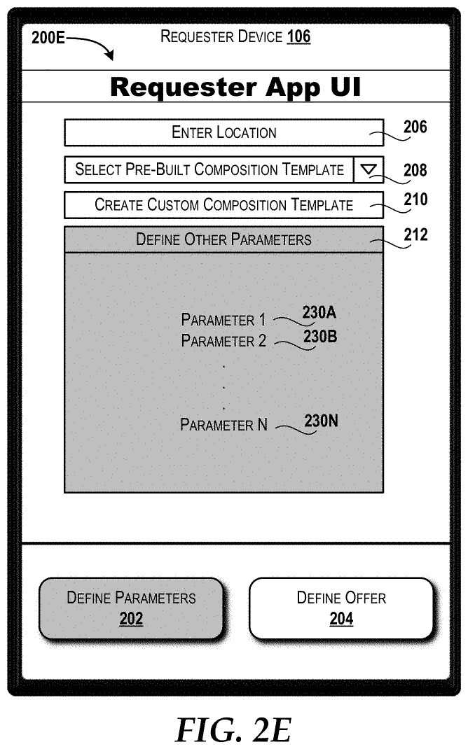

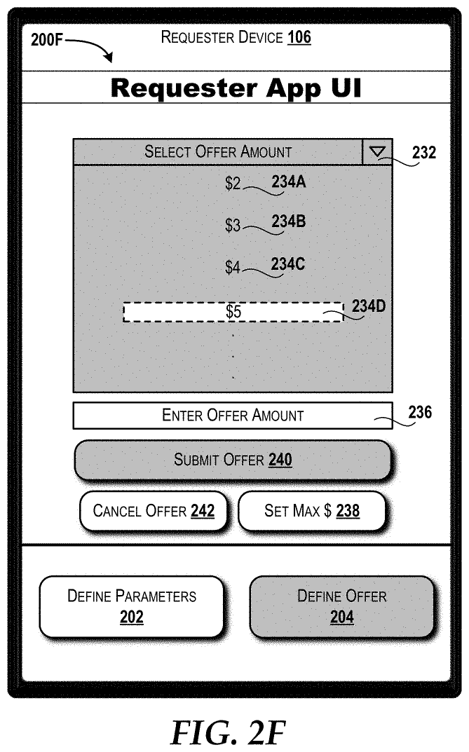

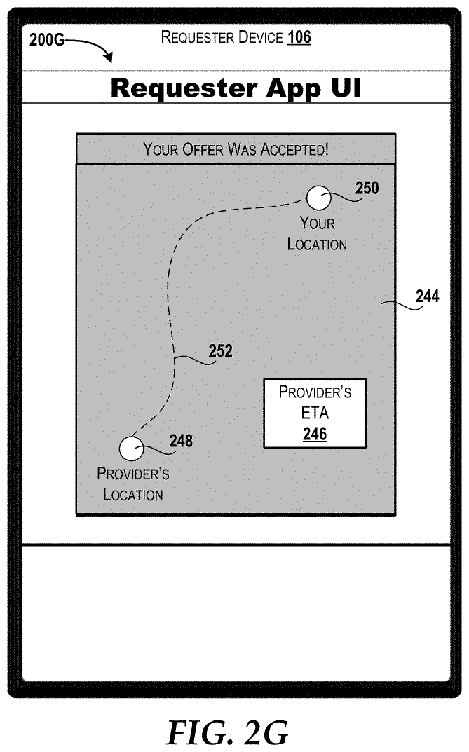

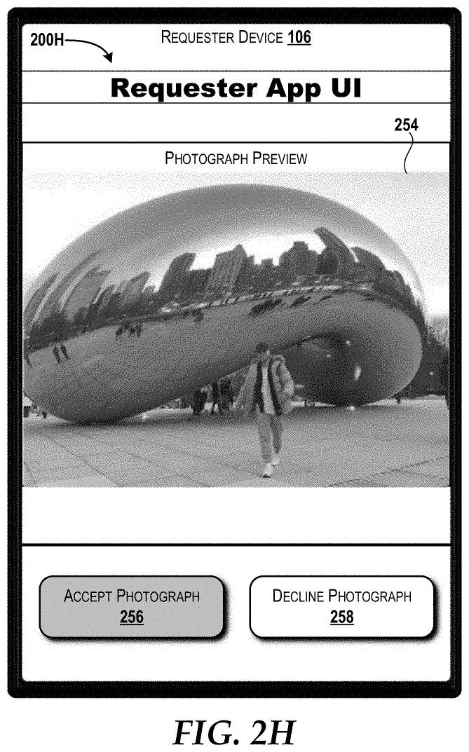

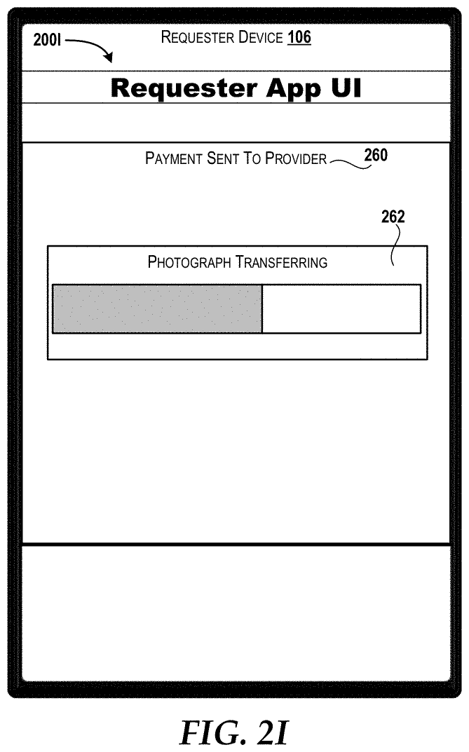

The parameters 124 may include a custom template. The requester application 110 can provide tools, such as through a graphical user interface (“GUI”), that allow the requester 102 to define the custom template. In some embodiments, the requester application 110 can instruct the requester 102 to frame an image in a viewfinder and outline the elements they would like to include in the custom template. An example of this is best shown in FIG. 2D, in which the location of a human subject and a background object are outlined.

The parameters 124 may include one or more other parameters. The other parameters can be any parameters other than location and template selection. For example, the other parameters may identify a particular time of day or a timeframe, weather preference (e.g., sunny, rainy, or overcast, image filter preference (if any), suggested exposure settings such as aperture (e.g., f-stop number), shutter speed, and ISO, any combination thereof, and the like. The other parameters may provide general guidance to the providers 116 such as a description of the style (e.g., dramatic, action, candid, etc.) the requester 102 would like expressed in the photograph 104. This can inform the providers 116 with an idea of how the photograph 104 should look in addition to any specific guidance provided by way of a composition template.

The photograph request 122 also can include or can be associated with the offer 126. The offer 126 can be a monetary offer, an item offer, a service offer, a custom offer (with conditions set by the requester 102), or some other type of offer that the requester 102 agrees to honor in compensation to the provider 116 who accepts the photograph request 122 and successfully takes the desired photograph 104. In some embodiments, the offer 126 functions as a reverse bid. In some embodiments, the offer 126 is a minimum offer, which may then be bid up by the providers 116 in an auction-style setup.

The requester device 106 can send the photograph request 122 to one or more of the provider devices 114. In some embodiments, the requester device 106 can broadcast the photograph request 122 in the area 120 such that any provider device 114 in the area 120 can receive the photograph request 122. The provider application 112 can provide an option to activate and deactivate provider status such that when provider status is active, the provider application 112 is capable of receiving the photograph request 122. In the illustrated example, the requester device 106 can send a first photograph request 122A to a first provider device 114A associated with a first provider 116A, a second photograph request 122B to a second provider device 114B associated with a second provider 116B, and an n^{th} photograph request 122N to an n^{th} provider device 114N associated with an n^{th} provider 116N. In some embodiments, the requester application 110 can post the photograph request 122 to a marketplace 132, which can present photograph requests 122 from the requester 102 and optionally one or more other requesters (not shown) and associated offer(s) 126. The providers 116 can view the marketplace 132 through the provider applications 112 and can accept photograph requests 122 from the requester 102 and/or other requesters (not shown).

After the photograph request 122 is accepted by the provider 116, the provider application 112 can instruct the provider 116 to proceed to the location identified in the photograph request 122 and may provide directions and/or a map to assist. When the provider 116 is ready to capture the photograph 104, the provider application 112 can load any parameters 124, pre-built composition template 128, or custom template identified in the photograph request 122 and allow the provider 116 to take the photograph 104. After the photograph 104 is captured, the provider application 112 can send a preview of the photograph 104 to the requester application 110 for the requester 102 to view and either accept or decline. The preview may be a full fidelity or partial fidelity version of the photograph 104. The requester 102 can accept the photograph 104, in which case the photograph 104 can be transferred to the requester device 106 and the offer 126 can be fulfilled (e.g., the requester 102 pays an agreed upon monetary amount to the provider 116). The photograph 104 may be stored locally on the requester device 106 and/or uploaded to a photograph repository 134 of the photograph composition system 108. In addition to or as an alternative to the photograph repository 134 of the photograph composition system 108, the requester device 106 can, at the discretion of the requester 102, upload the photograph 104 to a photograph service, which may facilitate storage, editing, printing, and/or other functionality. The requester 102 can decline the photograph 104, in which case the requester 102 may ask the provider 116 to retake the photograph 104 or decline further service from that provider 116. In some embodiments, the marketplace 132 can include a review system through which requesters 102 can review providers 116. The review system can include a score system (e.g., 1-10 or 5-star) and/or written reviews. The review system may also be a simple like/dislike system (e.g., thumbs up or thumbs down).

Payment can be arranged through the requester application 110 and the provider application 112, which may be configured to execute one or more application programming interfaces (“APIs”) to access one or more payment platforms (e.g., a mobile payment service such as VENMO, a bank or credit union, a credit card processor, or other financial entity) to complete the transaction. The exchange of physical currency is also contemplated. In some embodiments, the photograph 104 can be transferred and/or stored, and/or payment (i.e., fulfilling the offer 126) can be completed on a distributed ledger 136 such as a blockchain. The distributed ledger 136 can implement smart contracts to ensure the requester 102 and the provider 116 perform tasks required of them for a successful transaction. In some embodiments, the photograph 104 can be provided as or part of a non-fungible token (“NFT”) 138 on the distributed ledger.

Turning now to FIGS. 2A-2I, user interface diagrams illustrating several aspects of an example requester application user interface 200 of the requester application 110 will be described, according to illustrative embodiments of the concepts and technologies disclosed herein. The requester application user interface 200 should not be construed as being limiting to the functionality that can be provided by the requester application 110. Any soft buttons, menus, options, textboxes, prompts, and other user interface elements that are illustrated may have any shape, color, name, format, and/or other visual characteristics, and are not limited in any way to the examples shown. Moreover, the user interface elements can be interacted with via hardware buttons, touchscreen, touch pad, controllers, camera-based hardware, any combination thereof, and/or the like.

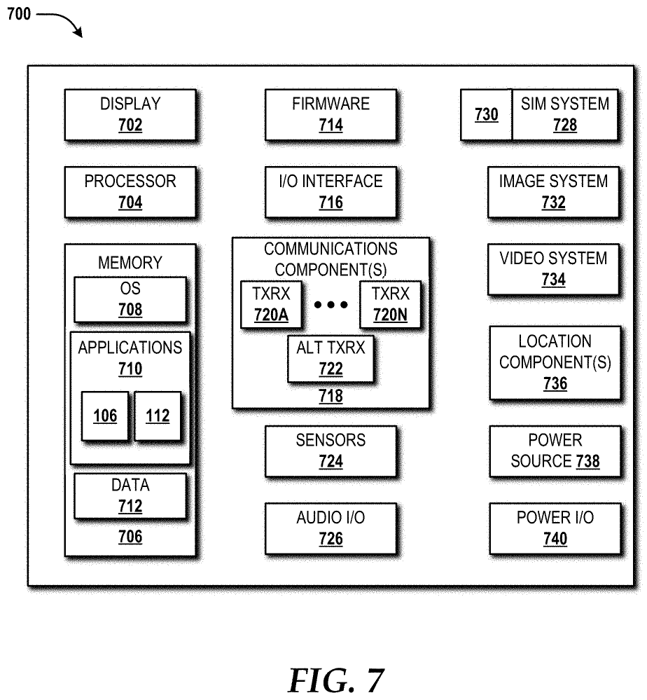

Turning first to FIG. 2A, the requester application user interface 200A is presented on a display (best shown in FIG. 7) of the requester device 106. The requester application user interface 200A includes a “define parameters” soft button 202 and a “define offer” soft button 204. In the illustrated example, the “define parameters” soft button 202 has been selected, and upon selection, a “location” drop-down menu 206, a “select pre-built composition template” drop-down menu 208, a “create custom composition template” soft button 210, and a “define other parameters” soft button 212 are presented. The “location” drop-down menu 206 has been selected and a “current location” option 214, an “enter location” option 216, and a “find photo opportunity” option 218 are presented. Upon selection of the “current location” option 214, the requester device 106 can use GPS, cellular triangulation, or other location determining technique to determine the current location of the requester device 106. Upon selection of the “enter location” option 216, the requester 102 can be prompted to enter a custom location via latitude/longitude coordinates, address, or well-known named location (e.g., a national monument. In the illustrated example, the find photo opportunity option 218 has been selected, which causes the requester application user interface 200B shown in FIG. 2B to be presented on the display of the requester device 106.

Turning to FIG. 2B, the requester application user interface 200B includes an expanded view of the “photo opportunities” option 218 that shows multiple landmark photo opportunities 220A-220N and multiple user recommended photo opportunities 222A-222N. The landmark photo opportunities 220A-220N can identify the locations of famous landmarks. The user recommended photo opportunities 222A-222N can identify photo opportunities that have been recommended by other users, including other requesters 102, other providers 116, and/or other individuals. The user recommended photo opportunities 222A-222N can be defined via the requester application 110 and/or the provider application 112, via social media, via a web interface, or other manner. It is contemplated that the landmark photo opportunities 220A-220N and the user recommended photo opportunities 222A-222N can be filtered based upon the current location of the requester device 106. For example, all landmark photo opportunities 220A-220N and user recommended photo opportunities 222A-222N within a specified range (e.g., 100 feet or 5 miles) of the current location of the requester device 106 can be presented in the expanded view of the photo opportunities option 218.

Turning now to FIG. 2C, the requester application user interface 200C includes an expanded view of the “select pre-built composition template” drop-down menu 208 that shows multiple pre-built template options 224A-224N for using one or more pre-built composition templates 128 that can define, at least in part, a desired composition of the photograph 104. The pre-built composition template(s) 128 can be stored by the photography composition system 108 in the composition template repository 130. The elements of composition that can be utilized to define, at least in part, the pre-built composition template 128 can include patterns, texture, symmetry, asymmetry, depth of field, lines, curves, frames, contrast, color, viewpoint, depth, negative space, filled space, foreground, background, visual tension, shapes, or any combination thereof. It is contemplated that one or more other parameters 124 may influence which pre-built composition templates 128 are available for selection. For example, a pre-built composition template 128 may be defined for a particular photo opportunity location and may only be available when the requester device 106 is located within the area 120 that includes the photo opportunity location. In addition to or as an alternative to the pre-built composition template 128 being particular to a photo opportunity location or other location, the pre-built composition template 128 may be generic such as to provide a basic composition for portraits, landscapes, or other photograph types.

Turning now to FIG. 2D, the requester application user interface 200D shows that the “create custom composition template” soft button 210 has been selected. The requester application 110 can instruct the requester 102 to frame an image 225 in a viewfinder and to outline the elements they would like to include in the custom template. In the illustrated example, the requester 102 has outlined a background object 226 and a human subject 228. In some embodiments, the requester application 110 can highlight elements of the image 225 that are likely to be desirable. For example, machine learning image recognition technology can be used to identify objects of interest and/or people and the requester 102 can confirm for inclusion in the custom template. Placeholders can be used for people, animals, and/or other subjects that are not present in the image 225. For example, the requester application 110 may provide various size placeholders that can be positioned over the image 225 and tagged with the intended element (e.g., a person or object).

Turning now to FIG. 2E, the requester application user interface 200E shows that the “define other parameters” soft button 212 has been selected. The requester 102 can define one or more other parameters 230A-230N. The other parameters 230A-230N can be any parameters other than location and template selection. For example, the other parameters 230A-230N may identify a particular time of day or a timeframe, weather preference (e.g., sunny, rainy, or overcast, image filter preference (if any), suggested exposure settings such as aperture (e.g., f-stop number), shutter speed, and ISO, any combination thereof, and the like. The other parameters 230A-230N may provide general guidance to the providers 116 such as a description of the style (e.g., dramatic, action, candid, etc.) that the requester 102 would like expressed in the photograph 104. This can inform the providers 116 with an idea of how the photograph 104 should look in addition to any specific guidance provided by way of a composition template.

Turning now to FIG. 2F, the requester application user interface 200F shows that the “define offer” soft button 204 has been selected. In response, a “select offer amount” drop-down menu 232 that includes pre-set offer amounts 234A-234D can be presented. The requester 102 can select one of the pre-set offer amounts 234A-234D, enter a custom amount in an “enter offer amount” textbox 236, or set a pre-defined maximum offer via a “set maximum offer” soft button 238. After an offer amount is specified, the requester 102 can submit the offer via a “submit offer” soft button 240 or cancel the offer via a “cancel offer” soft button 242. In the illustrated example, the “submit offer” soft button 240 has been selected. In response, the requester application 110 can submit the offer 126 in the photograph request 122 to the provider devices 114 in the area 120 and/or to the marketplace 132.

Turning now to FIG. 2G, the requester application user interface 200G shows a requester view map 244 that includes an estimated time of arrival 246 for the provider 116 to inform the requester 102 of when to expect the provider 116, a provider location 248, a requester location 250, and a travel route 252. The requester view map 244, the estimated time of arrival 246, the provider location 248, the requester location 250, and the travel route 252 can be updated as the provider 116 travels towards the requester location 250.

Turning now to FIG. 2H, the requester application user interface 200H shows a photograph preview 254 received from the provider application 112. The requester 102 can review the photograph preview 254 and accept the photograph preview 254 by selecting an “accept photograph” soft button 256 or decline the photograph preview 254 by selecting a “decline photograph” soft button 258. In the illustrated example, the requester 102 has selected the “accept photograph” soft button 256 to accept the photograph preview 254. Upon acceptance, payment in accordance with the offer 126 can be transferred to the provider 116, the provider device 114, or an account associated with the provider 116.

Turning now to FIG. 2I, the requester application user interface 200I shows a payment confirmation 260 that payment has been provided to the provider 116 and a transfer status 262 indicating the status of the photograph 104 transferring from the provider device 114 or the photograph repository 134 to the requester device 106. After the photograph 104 has been transferred, the transaction between the requester 102 and the provider 116 is complete.

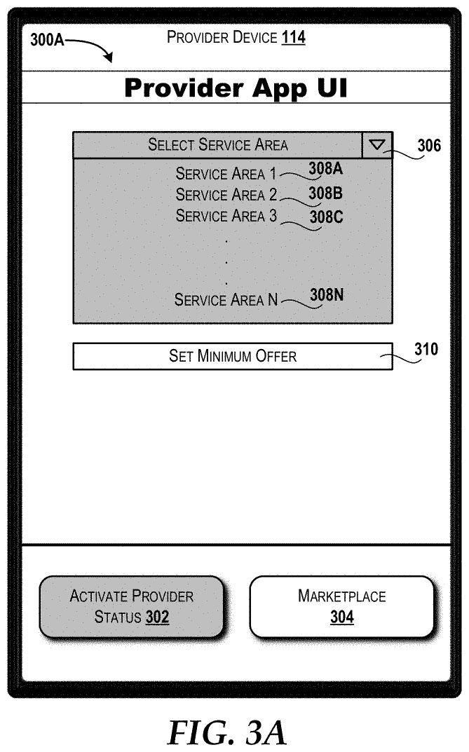

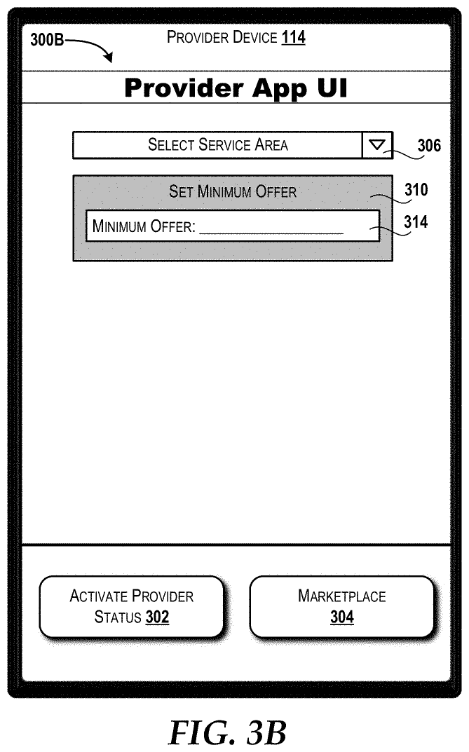

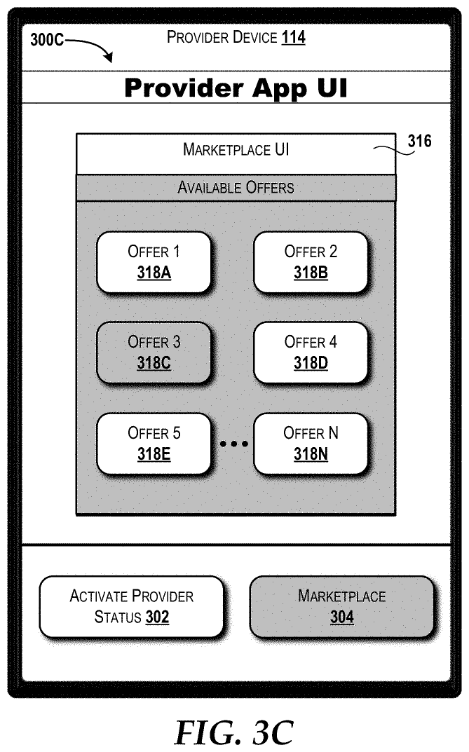

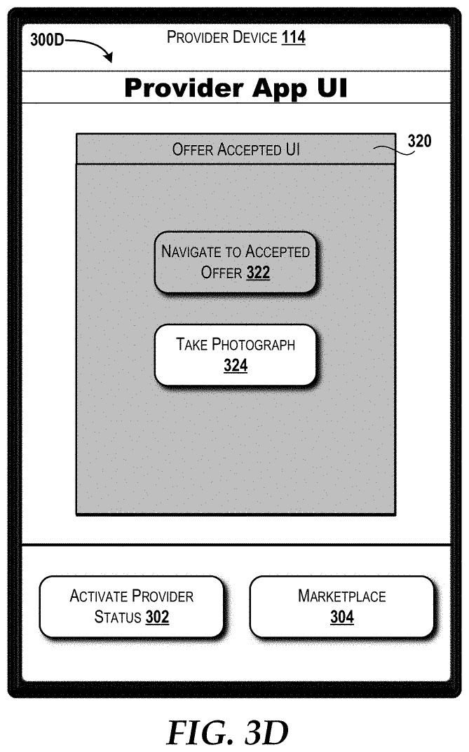

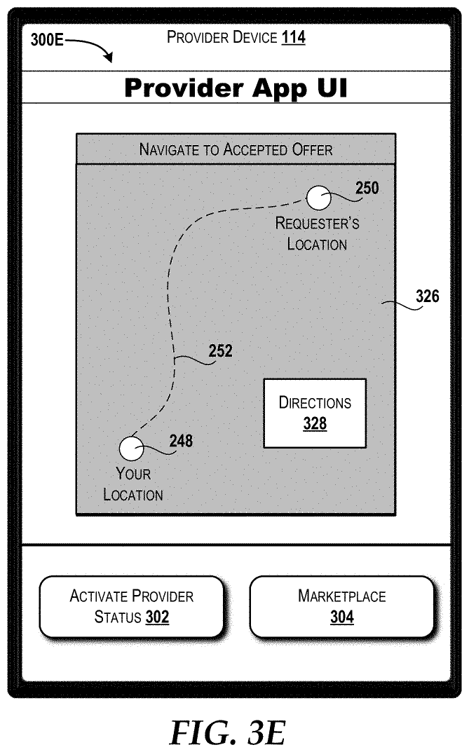

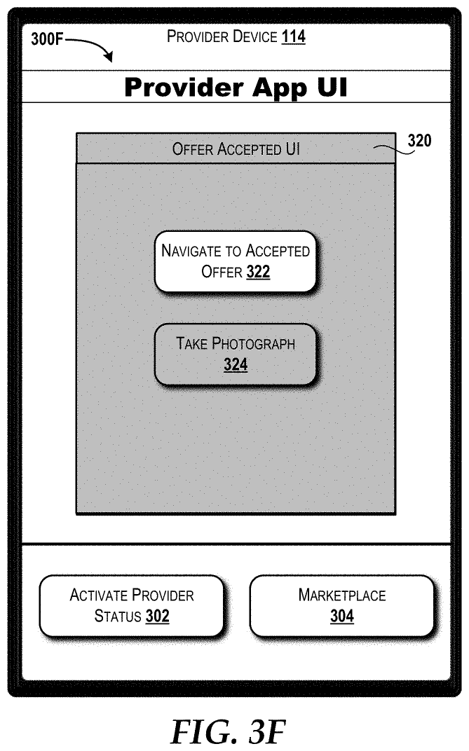

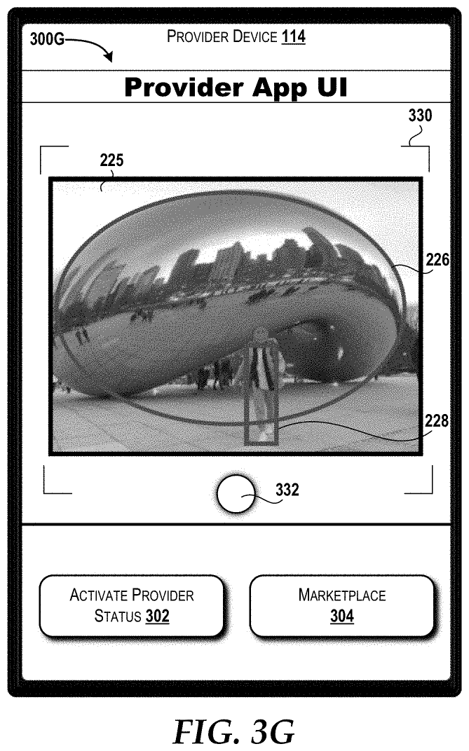

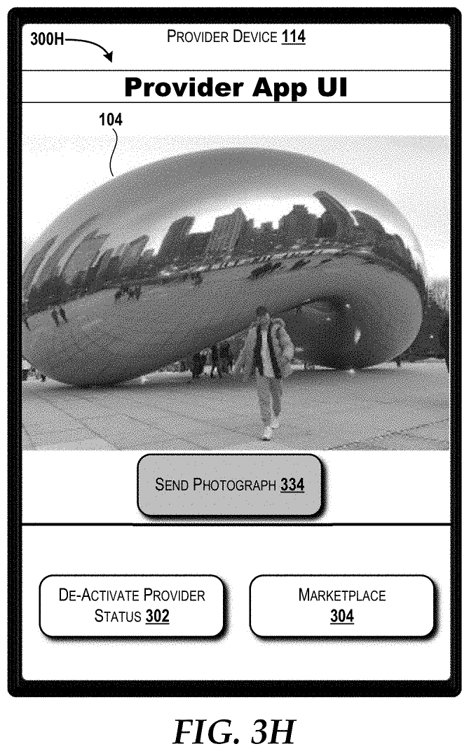

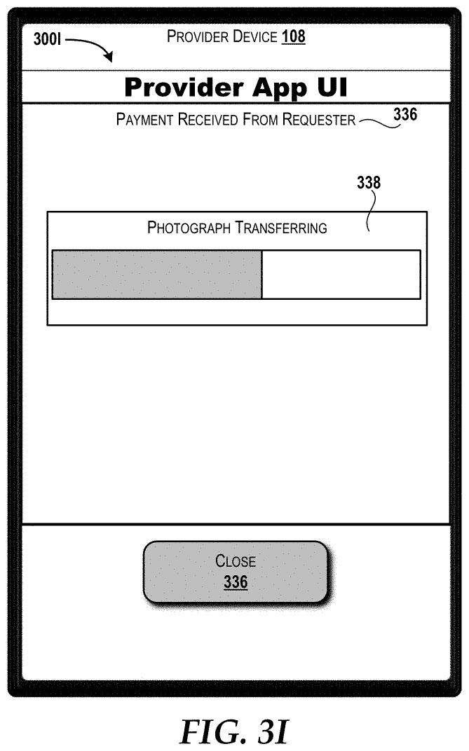

Turning now to FIGS. 3A-3I, user interface diagrams illustrating several aspects of an example provider application user interface 300 of the provider application 112 will be described, according to illustrative embodiments of the concepts and technologies disclosed herein. The provider application user interface 300 should not be construed as being limiting to the functionality that can be provided by the requester application 110. Any soft buttons, menus, options, textboxes, prompts, and other user interface elements that are illustrated may have any shape, color, name, format, and/or other visual characteristics, and are not limited in any way to the examples shown. Moreover, the user interface elements can be interacted with via hardware buttons, touchscreen, touch pad, controllers, camera-based hardware, any combination thereof, and/or the like.

Turning first to FIG. 3A, the provider application user interface 300A is presented on a display (best shown in FIG. 7) of the provider device 114. The provider application user interface 300A includes an “activate provider status” soft button 302 and a “marketplace” soft button 304. In the illustrated example, the “activate provider status” soft button 302 has been selected to indicate that the provider 116 is available to receive photograph requests 122. In some embodiments, provider status is automatically enabled. For example, a “select service area” drop-down menu 306 can allow the provider 116 to define one or more service areas 308A-308N, which can be used to trigger provider status based on location using a geo-fence. The provider application user interface 300A also includes a “set minimum offer” soft button 310 that allows the provider 116 to filter any potential incoming photograph requests 122 and corresponding offers 126 based upon a minimum amount. Turning to FIG. 3B, the provider application user interface 300B includes an expanded view of the “set minimum offer” soft button 310 that includes a minimum offer text box 314 in which the provider 116 can enter the minimum amount.

Turning now to FIG. 3C, the provider application user interface 300C shows the “marketplace” soft button 304 has been selected, and in response, a marketplace user interface 316 is presented. The marketplace user interface 316 shows a plurality of offer options 318A-318N representative of offers 126 submitted by the requester 102 (and other requesters in this example). The provider 116 may actively search for offers through the marketplace user interface 316 and/or use the “activate provider status” soft button 302 to accept photograph requests 122. In the illustrated example, one of the offers has been accepted.

Turning now to FIG. 3D, the provider application user interface 300D shows an “offer accepted” user interface 320 that includes a “navigate to accepted offer” option 322 and a “take photograph” option 324. The “navigate to accepted offer” option 322 has been selected. Turning now to FIG. 3E, the provider application user interface 300E shows a provider view map 326 that includes the provider location 248, the requester location 250, and the travel route 252. The provider application user interface 300E also include directions 328 to assist the provider 116 in navigating to the requester 102 to take the photograph 104. The provider view map 326, the provider location 248, the requester location 140, the travel route 252, and the directions 328 can be updated as the provider 116 travels towards the requester location 250.

Turning now to FIG. 3F, the provider application user interface 300F shows the “take photograph” option 324 has been selected from the “offer accepted” user interface 320, and in response, a camera viewfinder 330 can be presented as shown in FIG. 3G. The provider 116 can use the camera viewfinder 330 to preview the image 225 and ensure the background object 226 and the human subject 228 are properly aligned according to the template. When the provider 116 is satisfied with the image 225, they can select a camera shutter soft button 332 to capture the photograph 104. The provider 116 can retake the photograph 104 if desired. As shown in FIG. 3H, the provider 116 can select a “send photograph” option 334 when the provider 116 is ready to send the photograph 104 to the requester 102.

Turning now to FIG. 3I, the provider application user interface 300I shows a “payment received” confirmation 336 that payment has been received from the requester 102 and a transfer status 338 indicating the status of the photograph 104 transferring from the provider device 114 or the photograph repository 134 to the requester device 106. After the photograph 104 has been transferred, the transaction between the requester 102 and the provider 116 is complete.

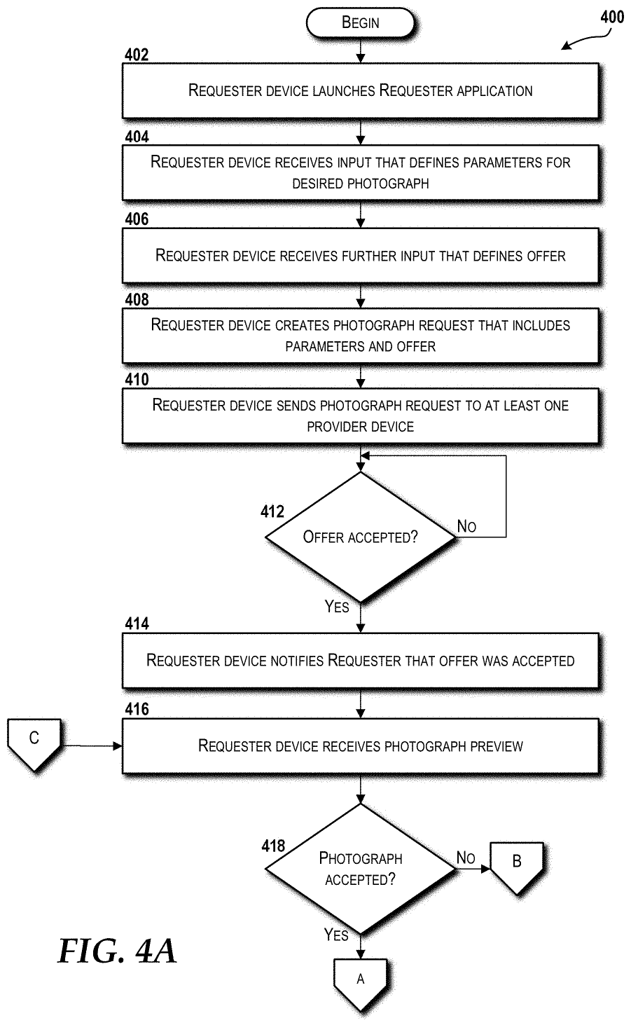

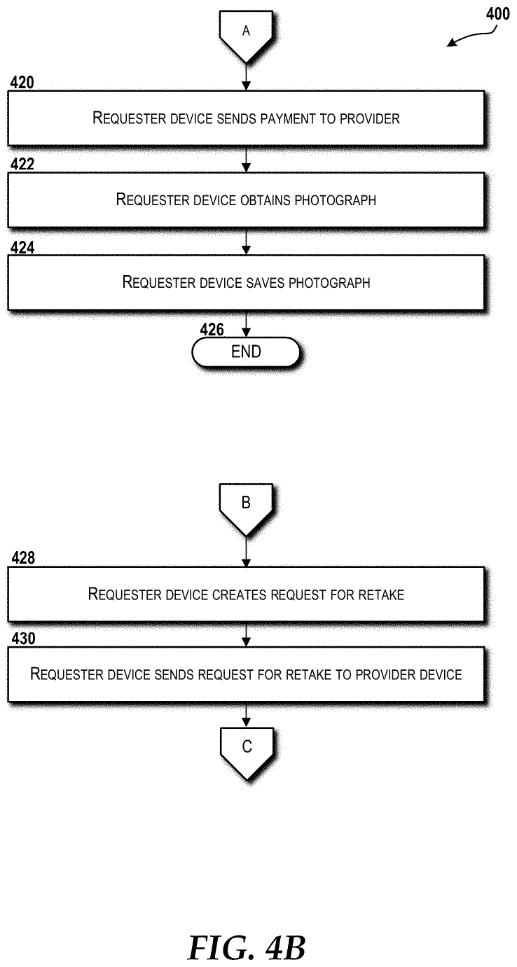

Turning now to FIGS. 4A-4B, flow diagrams illustrating aspects of a method 400 for utilizing a photography composition service from the perspective of a requester device 106 will be described, according to an illustrative embodiment of the concepts and technologies disclosed herein. It should be understood that the operations of the methods disclosed herein is not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the methods disclosed herein can be ended at any time and need not be performed in its entirety. Some or all operations of the methods, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof is used to refer to causing a processor of a computing system or device, or a portion thereof, to perform one or more operations, and/or causing the processor to direct other components of the computing system or device to perform one or more of the operations.

For purposes of illustrating and describing the concepts of the present disclosure, operations of the method disclosed herein are described as being performed alone or in combination via execution of one or more software modules, and/or other software/firmware components described herein. It should be understood that additional and/or alternative devices and/or network nodes can provide the functionality described herein via execution of one or more modules, applications, and/or other software. Thus, the illustrated embodiments are illustrative, and should not be viewed as being limiting in any way.

The method 400 begins and proceeds to operation 402. At operation 402, the requester device 106 launches the requester application 110. From operation 402, the method 400 proceeds to operation 404. At operation 404, the requester device 106 receives input that defines the parameters 124 for the desired photograph 104. From operation 404, the method 400 proceeds to operation 406. At operation 406, the requester device 106 receives further input that defines the offer 126. From operation 406, the method 400 proceeds to operation 408. At operation 408, the requester device 106 creates the photograph request 122 that includes the parameters 124 and the offer 126. From operation 408, the method 400 proceeds to operation 410. At operation 410, the requester device 106 sends the photograph request 122 to at least one of the provider devices 114. Alternatively or additionally, the requester device 106 can send the photograph request 122 to the photography composition system 108. The photography composition system 108 can include the photograph request 122 and the corresponding offer 126 in the marketplace 132.

From operation 410, the method 400 proceeds to operation 412. At operation 412, the requester device 106 determines if the offer 126 was accepted. If not, the method 400 returns to operation 412 and the method 400 repeats until the offer 126 is accepted. It is contemplated that an offer timeout may be triggered after a predetermined time has elapsed without the offer 126 being accepted. Alternatively, the requester application 110 may include an option to withdraw the offer 126. If the offer 126 was accepted, the method 400 proceeds to operation 414.

At operation 414, the requester device 106 notifies the requester 102 that the offer 126 was accepted. After the offer 126 is accepted, the requester device 106 also can provide the requester view map 244 and/or the provider's ETA 246, such as in the example shown in FIG. 2G. From operation 414, the method 400 proceeds to operation 416. At operation 416, the requester device 106 receives the photograph preview 254, such as in the example shown in FIG. 2H. From operation 416, the method 400 proceeds to operation 418. At operation 418, the requester device 106 determines if the photograph preview 254 has been accepted. For example, the requester device 106 may receive an indication of acceptance, such as the “accept photograph” soft button 256 being selected in the example shown in FIG. 2H. Alternatively, for example, the requester device 106 may receive an indication of rejection via a button press, such as the “decline photograph” soft button 258 being selected in the example shown in FIG. 2H.

If the photograph 104 is accepted at operation 418, the method 400 proceeds to operation 420 shown in FIG. 4B. At operation 420, the requester device 106 sends payment to the provider 116 in accordance with the offer 126. From operation 420, the method 400 proceeds to operation 422. At operation 422, the requester device 106 obtains the photograph 104. From operation 422, the method 400 proceeds to operation 424. At operation 424, the requester device 106 saves the photograph 104. From operation 424, the method 400 proceeds to operation 426. The method 400 can end at operation 426.

Returning to FIG. 4A, and particularly operation 418, if the photograph 104 is rejected, the method 400 proceeds to operation 428 in FIG. 4B. At operation 428, the requester device 106 creates a request for the provider 116 to retake the photograph 104. The request can be generated automatically in response to the requester 102 selecting the “decline photograph” soft button 258 (shown in FIG. 2H). From operation 428, the method 400 proceeds to operation 430. At operation 430, the requester device 106 sends the request for retake to the provider device 114. From operation 430, the method 400 returns to operation 416 and the method 400 proceeds as described above until the photograph 104 is accepted by the requester 102. It is contemplated that at any time the requester 102 and/or the provider 116 may be permitted to cancel the transaction. Whether or not either party may cancel the transaction can be incorporated into a smart contract stored on the distributed ledger 136.

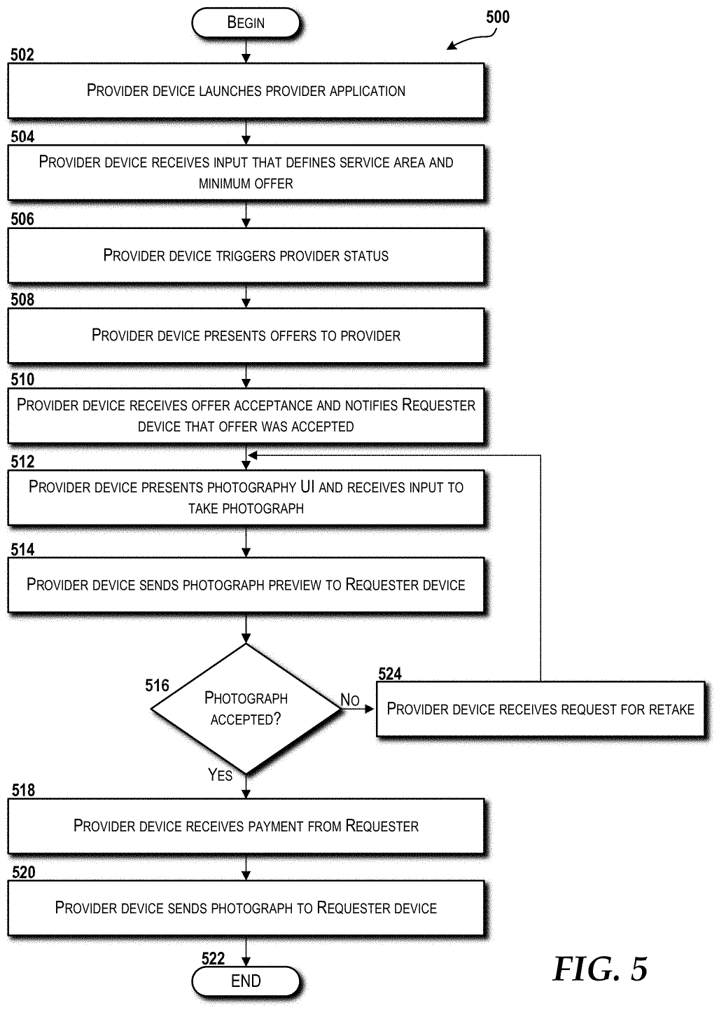

Turning now to FIG. 5, a flow diagram illustrating aspects of a method 500 for utilizing a photography composition service from the perspective of the provider device 114 will be described, according to an illustrative embodiment of the concepts and technologies disclosed herein. The method 500 begins and proceeds to operation 502. At operation 502, the provider device 114 launches the provider application 112. From operation 502, the method 500 proceeds to operation 504. At operation 504, the provider device 114 receives input that defines a service area and a minimum offer. From operation 504, the method 500 proceeds to operation 506. At operation 506, the provider device 114 triggers provider status based on location using a geo-fence defined by the service area input at operation 504. From operation 506, the method 500 proceeds to operation 508. At operation 508, the provider device 114 presents one or more offers 126 to the provider 116. The offers 126 can be received from the requester device 106 and/or via the marketplace 132.

From operation 508, the method 500 proceeds to operation 510. At operation 510, the provider device 114 receives input of an offer acceptance and the provider device 114 notifies the requester device 106 that the offer 126 was accepted. From operation 510, the method 500 proceeds to operation 512. At operation 512, the provider device 114 presents a photography user interface (see example in FIG. 3G) and receives input to take the photograph 104. From operation 512, the method 500 proceeds to operation 514. At operation 514, the provider device 114 sends the photograph preview 254 to the requester device 106.

From operation 514, the method 500 proceeds to operation 516. At operation 516, the provider device 114 determines if the photograph 104 was accepted (e.g., by receiving an indication of acceptance or rejection from the requester device 106). If the photograph 104 was accepted, the method 500 proceeds to operation 518. At operation 518, the provider device 114 receives payment from the requester 102. From operation 518, the method 500 proceeds to operation 520. At operation 520, the provider device 114 sends the photograph 104 to the requester device 106. From operation 520, the method 500 proceeds to operation 522. At operation 522, the method 500 can end.

Returning to operation 516, if the photograph 104 was rejected, the method 500 proceeds to operation 524. At operation 524, the provider device 114 receives a request for retake. The method 500 then returns to operation 512 and the method 500 proceeds as described above.

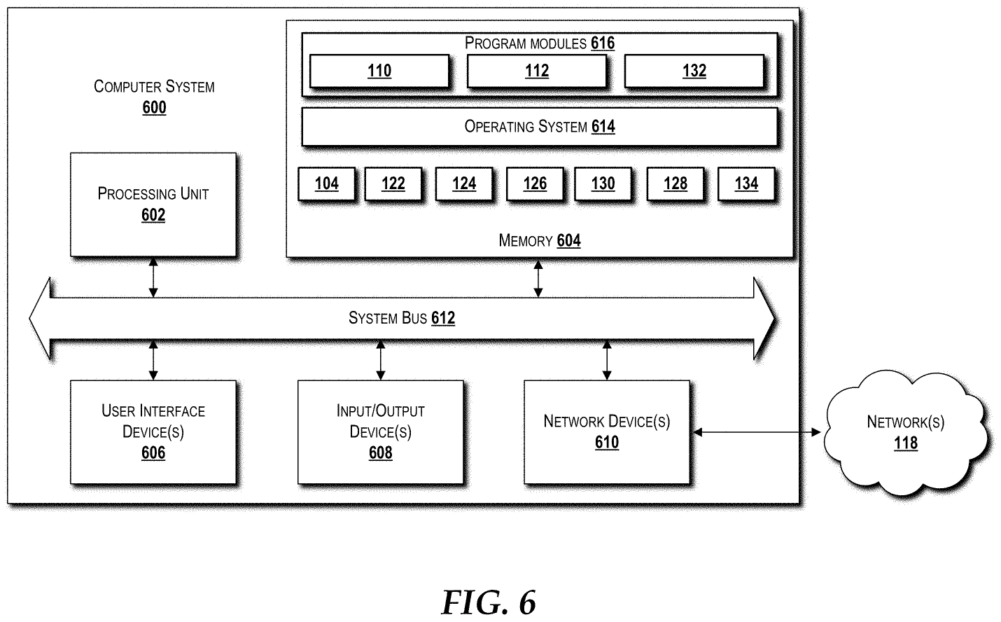

Turning now to FIG. 6, a block diagram illustrating a computer system 600 configured to provide the functionality described herein in accordance with various embodiments. In some embodiments, the requester device 106 is configured the same as or similar to the computer system 600. In some embodiments, the provider device(s) 114 is/are configured the same as or similar to the computer system 600. In some embodiments, the photography composition system 108 is configured the same as or similar to the computer system 600. The computer system 600 includes a processing unit 602, a memory 604, one or more user interface devices 606, one or more input/output (“I/O”) devices 608, and one or more network devices 610, each of which is operatively connected to a system bus 612. The bus 612 enables bi-directional communication between the processing unit 602, the memory 604, the user interface devices 606, the I/O devices 608, and the network devices 610.

The processing unit 602 may be a standard central processor that performs arithmetic and logical operations, a more specific purpose programmable logic controller (“PLC”), a programmable gate array, or other type of processor known to those skilled in the art and suitable for controlling the operation of the server computer. The processing unit 602 can be a single processing unit or a multiple processing unit that includes more than one processing component. Processing units are generally known, and therefore are not described in further detail herein.

The memory 604 communicates with the processing unit 602 via the system bus 612. The memory 604 can include a single memory component or multiple memory components. In some embodiments, the memory 604 is operatively connected to a memory controller (not shown) that enables communication with the processing unit 602 via the system bus 612. The memory 604 includes an operating system 614 and one or more program modules 616. The operating system 614 can include, but is not limited to, members of the WINDOWS, WINDOWS CE, and/or WINDOWS MOBILE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OSX, iOS, and/or families of operating systems from APPLE CORPORATION, the FREEBSD family of operating systems, the SOLARIS family of operating systems from ORACLE CORPORATION, other operating systems, and the like.

The program modules 616 may include various software and/or program modules described herein. The program modules 616 can include the requester application 110, the provider application 112, the marketplace 132, and/or other program modules. In some embodiments, multiple implementations of the computer system 600 can be used, wherein each implementation is configured to execute one or more of the program modules 616. The program modules 616 and/or other programs can be embodied in computer-readable media containing instructions that, when executed by the processing unit 602, perform the methods 400, 500 described herein. According to embodiments, the program modules 616 may be embodied in hardware, software, firmware, or any combination thereof. The memory 604 also can be configured to store the photographs 104, the photograph requests 122, the parameters 124, the offers 126, the composition template repository 130, the templates 128, the photograph repository 134, and/or other data disclosed herein.

By way of example, and not limitation, computer-readable media may include any available computer storage media or communication media that can be accessed by the computer system 600. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Computer storage media includes volatile and non-volatile, removable and non-removable media implemented in any method or technology for storage of information such as computer-readable instructions, data structures, program modules, or other data. Computer storage media includes, but is not limited to, random access memory (“RAM”), read-only memory (“ROM”), Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 600. In the claims, the phrase “computer storage medium,” “computer-readable storage medium,” and variations thereof does not include waves or signals per se and/or communication media, and therefore should be construed as being directed to “non-transitory” media only.

The user interface devices 606 may include one or more devices with which a user accesses the computer system 600. The user interface devices 606 may include, but are not limited to, computers, servers, personal digital assistants, cellular phones, or any suitable computing devices. The I/O devices 608 enable a user to interface with the program modules 616. In one embodiment, the I/O devices 608 are operatively connected to an I/O controller (not shown) that enables communication with the processing unit 602 via the system bus 612. The I/O devices 608 may include one or more input devices, such as, but not limited to, a keyboard, a mouse, or an electronic stylus. Further, the I/O devices 608 may include one or more output devices, such as, but not limited to, a display screen or a printer.

The network devices 610 enable the computer system 600 to communicate with other networks or remote systems via the network(s) 118. Examples of the network devices 610 include, but are not limited to, a modem, a radio frequency (“RF”) or infrared (“IR”) transceiver, a telephonic interface, a bridge, a router, or a network card. The network 118 may include a wireless network such as, but not limited to, a Wireless Local Area Network (“WLAN”) such as a WI-FI network, a Wireless Wide Area Network (“WWAN”), a Wireless Personal Area Network (“WPAN”) such as BLUETOOTH, a Wireless Metropolitan Area Network (“WMAN”) such a WiMAX network, or a cellular network. Alternatively, the network 118 may be a wired network such as, but not limited to, a Wide Area Network (“WAN”) such as the Internet, a Local Area Network (“LAN”) such as the Ethernet, a wired Personal Area Network (“PAN”), or a wired Metropolitan Area Network (“MAN”).

Turning now to FIG. 7, an illustrative mobile device 700 and components thereof will be described. In some embodiments, the requester device 106 and/or the provider device(s) 114 is/are configured similar to or the same as the mobile device 700. While connections are not shown between the various components illustrated in FIG. 7, it should be understood that some, none, or all of the components illustrated in FIG. 7 can be configured to interact with one another to carry out various device functions. In some embodiments, the components are arranged so as to communicate via one or more busses (not shown). Thus, it should be understood that FIG. 7 and the following description are intended to provide a general understanding of a suitable environment in which various aspects of embodiments can be implemented, and should not be construed as being limiting in any way.

As illustrated in FIG. 7, the mobile device 700 can include a display 702 for displaying data. According to various embodiments, the display 702 can be configured to display various GUI elements such as shown in FIGS. 2A-2I and 3A-3I, text, images, video, virtual keypads and/or keyboards, messaging data, notification messages, metadata, Internet content, device status, time, date, calendar data, device preferences, map and location data, combinations thereof, and/or the like. The mobile device 700 also can include a processor 704 and a memory or other data storage device (“memory”) 706. The processor 704 can be configured to process data and/or can execute computer-executable instructions stored in the memory 706. The computer-executable instructions executed by the processor 704 can include, for example, an operating system 708, one or more applications 710, other computer-executable instructions stored in the memory 706, or the like. In some embodiments, the applications 710 also can include the requester application 110 and/or the provider application 112. In some embodiments, the applications 710 also can include a UI application.

The UI application can interface with the operating system 708 to facilitate user interaction with functionality and/or data stored at the mobile device 700 and/or stored elsewhere. In some embodiments, the operating system 708 can include a member of the SYMBIAN OS family of operating systems from SYMBIAN LIMITED, a member of the WINDOWS MOBILE OS and/or WINDOWS PHONE OS families of operating systems from MICROSOFT CORPORATION, a member of the PALM WEBOS family of operating systems from HEWLETT PACKARD CORPORATION, a member of the BLACKBERRY OS family of operating systems from RESEARCH IN MOTION LIMITED, a member of the IOS family of operating systems from APPLE INC., a member of the ANDROID OS family of operating systems from GOOGLE LLC, and/or other operating systems. These operating systems are merely illustrative of some contemplated operating systems that may be used in accordance with various embodiments of the concepts and technologies described herein and therefore should not be construed as being limiting in any way.

The UI application can be executed by the processor 704 to aid a user in entering/deleting data, entering and setting user IDs and passwords for device access, configuring settings, manipulating content and/or settings, multimode interaction, interacting with other applications 710, and otherwise facilitating user interaction with the operating system 708, the applications 710, and/or other types or instances of data 712 that can be stored at the mobile device 700.

The applications 710, the data 712, and/or portions thereof can be stored in the memory 706 and/or in a firmware 714, and can be executed by the processor 704. The firmware 714 also can store code for execution during device power up and power down operations. It can be appreciated that the firmware 714 can be stored in a volatile or non-volatile data storage device including, but not limited to, the memory 706 and/or a portion thereof.

The mobile device 700 also can include an input/output (“I/O”) interface 716. The I/O interface 716 can be configured to support the input/output of data such as location information, presence status information, user IDs, passwords, and application initiation (start-up) requests. In some embodiments, the I/O interface 716 can include a hardwire connection such as a universal serial bus (“USB”) port, a mini-USB port, a micro-USB port, an audio jack, a PS2 port, an IEEE 1394 (“FIREWIRE”) port, a serial port, a parallel port, an Ethernet (RJ47) port, an RJ11 port, a proprietary port, combinations thereof, or the like. In some embodiments, the mobile device 700 can be configured to synchronize with another device to transfer content to and/or from the mobile device 700. In some embodiments, the mobile device 700 can be configured to receive updates to one or more of the applications 710 via the I/O interface 716, though this is not necessarily the case. In some embodiments, the I/O interface 716 accepts I/O devices such as keyboards, keypads, mice, interface tethers, printers, plotters, external storage, touch/multi-touch screens, touch pads, trackballs, joysticks, microphones, remote control devices, displays, projectors, medical equipment (e.g., stethoscopes, heart monitors, and other health metric monitors), modems, routers, external power sources, docking stations, combinations thereof, and the like. It should be appreciated that the I/O interface 716 may be used for communications between the mobile device 700 and a network device or local device.

The mobile device 700 also can include a communications component 718. The communications component 718 can be configured to interface with the processor 704 to facilitate wired and/or wireless communications with one or more networks, such as the network 118, the Internet, or some combination thereof. In some embodiments, the communications component 718 includes a multimode communications subsystem for facilitating communications via the cellular network and one or more other networks.

The communications component 718, in some embodiments, includes one or more transceivers. The one or more transceivers, if included, can be configured to communicate over the same and/or different wireless technology standards with respect to one another. For example, in some embodiments, one or more of the transceivers of the communications component 718 may be configured to communicate using Global System for Mobile communications (“GSM”), Code-Division Multiple Access (“CDMA”) CDMAONE, CDMA2000, Long-Term Evolution (“LTE”) LTE, and various other 2G, 2.5G, 3G, 4G, 4.5G, 5G, and greater generation technology standards. Moreover, the communications component 718 may facilitate communications over various channel access methods (which may or may not be used by the aforementioned standards) including, but not limited to, Time-Division Multiple Access (“TDMA”), Frequency-Division Multiple Access (“FDMA”), Wideband CDMA (“W-CDMA”), Orthogonal Frequency-Division Multiple Access (“OFDMA”), Space-Division Multiple Access (“SDMA”), and the like.

In addition, the communications component 718 may facilitate data communications using General Packet Radio Service (“GPRS”), Enhanced Data services for Global Evolution (“EDGE”), the High-Speed Packet Access (“HSPA”) protocol family including High-Speed Downlink Packet Access (“HSDPA”), Enhanced Uplink (“EUL”) (also referred to as High-Speed Uplink Packet Access (“HSUPA”), HSPA+, and various other current and future wireless data access standards. In the illustrated embodiment, the communications component 718 can include a first transceiver (“TxRx”) 720A that can operate in a first communications mode (e.g., GSM). The communications component 718 also can include an N^{th} transceiver (“TxRx”) 720N that can operate in a second communications mode relative to the first transceiver 720A (e.g., UMTS). While two transceivers 720A-720N (hereinafter collectively and/or generically referred to as “transceivers 720”) are shown in FIG. 7, it should be appreciated that less than two, two, and/or more than two transceivers 720 can be included in the communications component 718.

The communications component 718 also can include an alternative transceiver (“Alt TxRx”) 722 for supporting other types and/or standards of communications. According to various contemplated embodiments, the alternative transceiver 722 can communicate using various communications technologies such as, for example, WI-FI, WIMAX, BLUETOOTH, infrared, infrared data association (“IRDA”), near field communications (“NFC”), other RF technologies, combinations thereof, and the like. In some embodiments, the communications component 718 also can facilitate reception from terrestrial radio networks, digital satellite radio networks, internet-based radio service networks, combinations thereof, and the like. The communications component 718 can process data from a network such as the Internet, an intranet, a broadband network, a WI-FI hotspot, an Internet service provider (“ISP”), a digital subscriber line (“DSL”) provider, a broadband provider, combinations thereof, or the like.

The mobile device 700 also can include one or more sensors 724. The sensors 724 can include temperature sensors, light sensors, air quality sensors, movement sensors, accelerometers, magnetometers, gyroscopes, infrared sensors, orientation sensors, noise sensors, microphones proximity sensors, combinations thereof, and/or the like. Additionally, audio capabilities for the mobile device 700 may be provided by an audio I/O component 726. The audio I/O component 726 of the mobile device 700 can include one or more speakers for the output of audio signals, one or more microphones for the collection and/or input of audio signals, and/or other audio input and/or output devices.

The illustrated mobile device 700 also can include a subscriber identity module (“SIM”) system 728. The SIM system 728 can include a universal SIM (“USIM”), a universal integrated circuit card (“UICC”) and/or other identity devices. The SIM system 728 can include and/or can be connected to or inserted into an interface such as a slot interface 730. In some embodiments, the slot interface 730 can be configured to accept insertion of other identity cards or modules for accessing various types of networks. Additionally, or alternatively, the slot interface 730 can be configured to accept multiple subscriber identity cards. Because other devices and/or modules for identifying users and/or the mobile device 700 are contemplated, it should be understood that these embodiments are illustrative, and should not be construed as being limiting in any way.

The mobile device 700 also can include an image capture and processing system 732 (“image system”). The image system 732 can be configured to capture or otherwise obtain photos, videos, and/or other visual information. As such, the image system 732 can include cameras, lenses, charge-coupled devices (“CCDs”), combinations thereof, or the like. The mobile device 700 may also include a video system 734. The video system 734 can be configured to capture, process, record, modify, and/or store video content. Photos and videos obtained using the image system 732 and the video system 734, respectively, may be added as message content to an MMS message, email message, and sent to another device. The video and/or photo content also can be shared with other devices via various types of data transfers via wired and/or wireless communication devices as described herein.

The mobile device 700 also can include one or more location components 736. The location components 736 can be configured to send and/or receive signals to determine a geographic location of the mobile device 700. According to various embodiments, the location components 736 can send and/or receive signals from global positioning system (“GPS”) devices, assisted-GPS (“A-GPS”) devices, WI-FI/WIMAX and/or cellular network triangulation data, combinations thereof, and the like. The location component 736 also can be configured to communicate with the communications component 718 to retrieve triangulation data for determining a location of the mobile device 700. In some embodiments, the location component 736 can interface with cellular network nodes, telephone lines, satellites, location transmitters and/or beacons, wireless network transmitters and receivers, combinations thereof, and the like. In some embodiments, the location component 736 can include and/or can communicate with one or more of the sensors 724 such as a compass, an accelerometer, and/or a gyroscope to determine the orientation of the mobile device 700. Using the location component 736, the mobile device 700 can generate and/or receive data to identify its geographic location, or to transmit data used by other devices to determine the location of the mobile device 700. The location component 736 may include multiple components for determining the location and/or orientation of the mobile device 700.

The illustrated mobile device 700 also can include a power source 738. The power source 738 can include one or more batteries, power supplies, power cells, and/or other power subsystems including alternating current (“AC”) and/or direct current (“DC”) power devices. The power source 738 also can interface with an external power system or charging equipment via a power I/O component 740. Because the mobile device 700 can include additional and/or alternative components, the above embodiment should be understood as being illustrative of one possible operating environment for various embodiments of the concepts and technologies described herein. The described embodiment of the mobile device 700 is illustrative, and should not be construed as being limiting in any way.

As used herein, communication media includes computer-executable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared, and other wireless media. Combinations of the any of the above should also be included within the scope of computer-readable media.

By way of example, and not limitation, computer storage media may include volatile and non-volatile, removable and non-removable media implemented in any method or technology for storage of information such as computer-executable instructions, data structures, program modules, or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the mobile device 700 or other devices or computers described herein, such as the computer system 600 described above with reference to FIG. 6. In the claims, the phrase “computer storage medium,” “computer-readable storage medium,” and variations thereof does not include waves or signals per se and/or communication media, and therefore should be construed as being directed to “non-transitory” media only.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations may take place in the mobile device 700 in order to store and execute the software components presented herein. It is also contemplated that the mobile device 700 may not include all of the components shown in FIG. 7, may include other components that are not explicitly shown in FIG. 7, or may utilize an architecture completely different than that shown in FIG. 7.

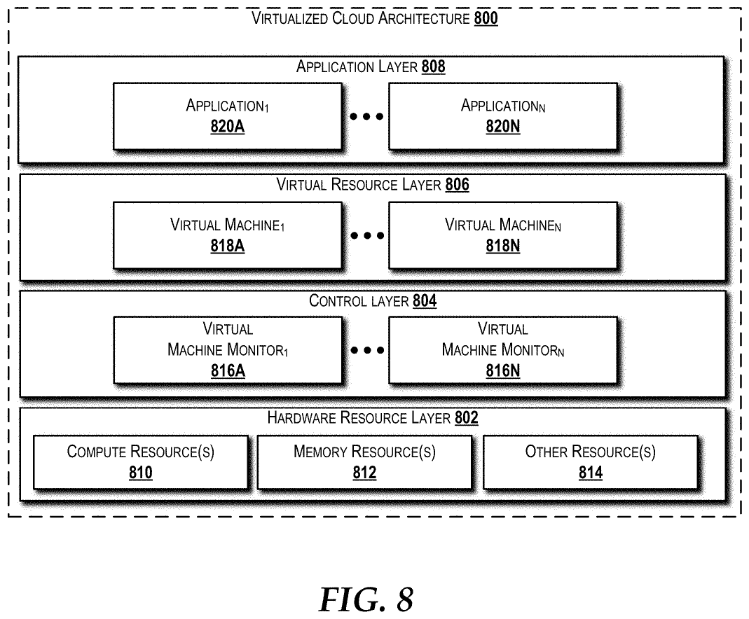

Turning now to FIG. 8, a block diagram illustrating an example virtualized cloud architecture 800 and components thereof will be described, according to an exemplary embodiment. In some embodiments, the virtualized cloud architecture 800 can be utilized to implement, at least in part, the photography composition system 108, the network(s) 118, or some portion thereof. The virtualized cloud architecture 800 is a shared infrastructure that can support multiple services and network applications. The illustrated virtualized cloud architecture 800 includes a hardware resource layer 802, a control layer 804, a virtual resource layer 806, and an application layer 808 that work together to perform operations as will be described in detail herein.

The hardware resource layer 802 provides hardware resources, which, in the illustrated embodiment, include one or more compute resources 810, one or more memory resources 812, and one or more other resources 814. The compute resource(s) 810 can include one or more hardware components that perform computations to process data, and/or to execute computer-executable instructions of one or more application programs, operating systems, and/or other software. The compute resources 810 can include one or more central processing units (“CPUs”) configured with one or more processing cores. The compute resources 810 can include one or more graphics processing unit (“GPU”) configured to accelerate operations performed by one or more CPUs, and/or to perform computations to process data, and/or to execute computer-executable instructions of one or more application programs, operating systems, and/or other software that may or may not include instructions particular to graphics computations. In some embodiments, the compute resources 810 can include one or more discrete GPUs. In some other embodiments, the compute resources 810 can include CPU and GPU components that are configured in accordance with a co-processing CPU/GPU computing model, wherein the sequential part of an application executes on the CPU and the computationally-intensive part is accelerated by the GPU. The compute resources 810 can include one or more system-on-chip (“SoC”) components along with one or more other components, including, for example, one or more of the memory resources 812, and/or one or more of the other resources 814. In some embodiments, the compute resources 810 can be or can include one or more SNAPDRAGON SoCs, available from QUALCOMM; one or more TEGRA SoCs, available from NVIDIA; one or more HUMMINGBIRD SoCs, available from SAMSUNG; one or more Open Multimedia Application Platform (“OMAP”) SoCs, available from TEXAS INSTRUMENTS; one or more customized versions of any of the above SoCs; and/or one or more proprietary SoCs. The compute resources 810 can be or can include one or more hardware components architected in accordance with an advanced reduced instruction set computing (“RISC”) machine (“ARM”) architecture, available for license from ARM HOLDINGS. Alternatively, the compute resources 810 can be or can include one or more hardware components architected in accordance with an x86 architecture, such an architecture available from INTEL CORPORATION of Mountain View, Cali., and others. Those skilled in the art will appreciate the implementation of the compute resources 810 can utilize various computation architectures, and as such, the compute resources 810 should not be construed as being limited to any particular computation architecture or combination of computation architectures, including those explicitly disclosed herein.

The memory resource(s) 812 can include one or more hardware components that perform storage operations, including temporary or permanent storage operations. In some embodiments, the memory resource(s) 812 include volatile and/or non-volatile memory implemented in any method or technology for storage of information such as computer-readable instructions, data structures, program modules, or other data disclosed herein. Computer storage media includes, but is not limited to, random access memory (“RAM”), read-only memory (“ROM”), Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store data and which can be accessed by the compute resources 810.

The other resource(s) 814 can include any other hardware resources that can be utilized by the compute resources(s) 810 and/or the memory resource(s) 812 to perform operations described herein. The other resource(s) 814 can include one or more input and/or output processors (e.g., network interface controller or wireless radio), one or more modems, one or more codec chipset, one or more pipeline processors, one or more fast Fourier transform (“FFT”) processors, one or more digital signal processors (“DSPs”), one or more speech synthesizers, and/or the like.

The hardware resources operating within the hardware resource layer 802 can be virtualized by one or more virtual machine monitors (“VMMs”) 816A-816N (also known as “hypervisors”; hereinafter “VMMs 816”) operating within the control layer 804 to manage one or more virtual resources that reside in the virtual resource layer 806. The VMMs 816 can be or can include software, firmware, and/or hardware that alone or in combination with other software, firmware, and/or hardware, manages one or more virtual resources operating within the virtual resource layer 806.

The virtual resources operating within the virtual resource layer 806 can include abstractions of at least a portion of the compute resources 810, the memory resources 812, the other resources 814, or any combination thereof. These abstractions are referred to herein as virtual machines (“VMs”). In the illustrated embodiment, the virtual resource layer 806 includes VMs 818A-818N (hereinafter “VMs 818”). Each of the VMs 818 can execute one or more applications 820A-820N in the application layer 808.

Turning now to FIG. 9, details of the network 118 are illustrated, according to an illustrative embodiment. The network 118 includes a cellular network 902, a packet data network 904, and a circuit switched network 906 (e.g., a public switched telephone network). The cellular network 902 includes various components such as, but not limited to, base transceiver stations (“BTSs”), Node-Bs or e-Node-Bs, base station controllers (“BSCs”), radio network controllers (“RNCs”), mobile switching centers (“MSCs”), mobility management entities (“MMEs”), short message service centers (“SMSCs”), multimedia messaging service centers (“MMSCs”), home location registers (“HLRs”), home subscriber servers (“HSSs”), visitor location registers (“VLRs”), charging platforms, billing platforms, voicemail platforms, GPRS core network components, location service nodes, and the like. The cellular network 902 also includes radios and nodes for receiving and transmitting voice, data, and combinations thereof to and from radio transceivers, networks, the packet data network 904, and the circuit switched network 906.

A mobile communications device 908, such as, for example, the requester device 106, the provider device 114, a cellular telephone, a user equipment, a mobile terminal, a PDA, a laptop computer, a handheld computer, and combinations thereof, can be operatively connected to the cellular network 902. The mobile communications device 908 can be configured similar to or the same as the mobile device 700 described above with reference to FIG. 7.

The cellular network 902 can be configured as a GSM network and can provide data communications via GPRS and/or EDGE. Additionally, or alternatively, the cellular network 902 can be configured as a 3G Universal Mobile Telecommunications System (“UMTS”) network and can provide data communications via the HSPA protocol family, for example, HSDPA, EUL, and HSPA+. The cellular network 902 also is compatible with mobile communications standards such as LTE, or the like, as well as evolved and future mobile standards.

The packet data network 904 includes various systems, devices, servers, computers, databases, and other devices in communication with one another, as is generally known. In some embodiments, the packet data network 904 is or includes one or more WI-FI networks, each of which can include one or more WI-FI access points, routers, switches, and other WI-FI network components. The packet data network 904 devices are accessible via one or more network links. The servers often store various files that are provided to a requesting device such as, for example, a computer, a terminal, a smartphone, or the like. Typically, the requesting device includes software for executing a web page in a format readable by the browser or other software. Other files and/or data may be accessible via “links” in the retrieved files, as is generally known. In some embodiments, the packet data network 904 includes or is in communication with the Internet. The circuit switched network 906 includes various hardware and software for providing circuit switched communications. The circuit switched network 906 may include, or may be, what is often referred to as a plain old telephone system (“POTS”). The functionality of a circuit switched network 906 or other circuit-switched network are generally known and will not be described herein in detail.

The illustrated cellular network 902 is shown in communication with the packet data network 904 and a circuit switched network 906, though it should be appreciated that this is not necessarily the case. One or more Internet-capable systems/devices 910 such as the photography composition system 108, a laptop, a portable device, or another suitable device, can communicate with one or more cellular networks 902, and devices connected thereto, through the packet data network 904. It also should be appreciated that the Internet-capable device 910 can communicate with the packet data network 904 through the circuit switched network 906, the cellular network 902, and/or via other networks (not illustrated).

As illustrated, a communications device 912, for example, a telephone, facsimile machine, modem, computer, or the like, can be in communication with the circuit switched network 906, and therethrough to the packet data network 904 and/or the cellular network 902. It should be appreciated that the communications device 912 can be an Internet-capable device, and can be substantially similar to the Internet-capable device 910.

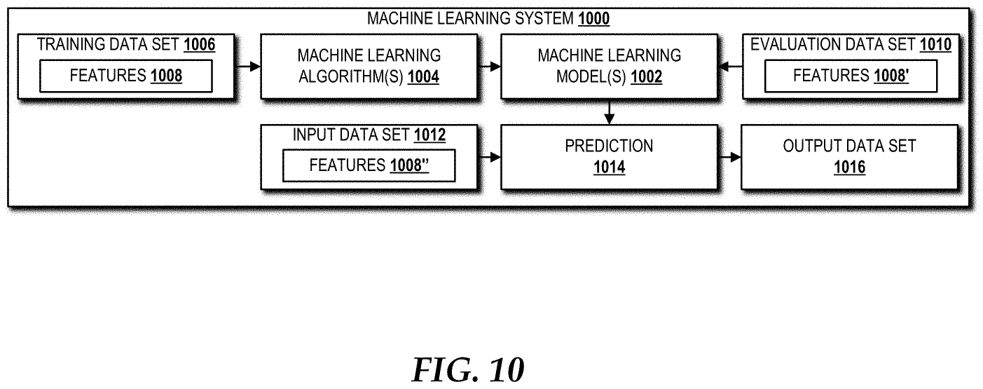

Turning now to FIG. 10, a machine learning system 1000 capable of implementing aspects of the embodiments disclosed herein will be described. In some embodiments, aspects of the requester application 110, the provider application 112, the marketplace 132, and/or other elements disclosed herein can be improved via machine learning. Accordingly, the requester device 106, the provider device(s) 114, and/or the photography composition system 108 can include the machine learning system 1000 or can be in communication with the machine learning system 1000.

The illustrated machine learning system 1000 includes one or more machine learning models 1002. The machine learning models 1002 can include, unsupervised, supervised, and/or semi-supervised learning models. The machine learning model(s) 1002 can be created by the machine learning system 1000 based upon one or more machine learning algorithms 1004. The machine learning algorithm(s) 1004 can be any existing, well-known algorithm, any proprietary algorithms, or any future machine learning algorithm. Some example machine learning algorithms 1004 include, but are not limited to, neural networks, gradient descent, linear regression, logistic regression, linear discriminant analysis, classification tree, regression tree, Naive Bayes, K-nearest neighbor, learning vector quantization, support vector machines, any of the algorithms described herein, and the like. Classification and regression algorithms might find particular applicability to the concepts and technologies disclosed herein. Those skilled in the art will appreciate the applicability of various machine learning algorithms 1004 based upon the problem(s) to be solved by machine learning via the machine learning system 1000.

The machine learning system 1000 can control the creation of the machine learning models 1002 via one or more training parameters. In some embodiments, the training parameters are selected modelers at the direction of an enterprise, for example. Alternatively, in some embodiments, the training parameters are automatically selected based upon data provided in one or more training data sets 1006. The training parameters can include, for example, a learning rate, a model size, a number of training passes, data shuffling, regularization, and/or other training parameters known to those skilled in the art.

The learning rate is a training parameter defined by a constant value. The learning rate affects the speed at which the machine learning algorithm 1004 converges to the optimal weights. The machine learning algorithm 1004 can update the weights for every data example included in the training data set 1006. The size of an update is controlled by the learning rate. A learning rate that is too high might prevent the machine learning algorithm 1004 from converging to the optimal weights. A learning rate that is too low might result in the machine learning algorithm 1004 requiring multiple training passes to converge to the optimal weights.

The model size is regulated by the number of input features (“features”) 1008 in the training data set 1006. A greater the number of features 1008 yields a greater number of possible patterns that can be determined from the training data set 1006. The model size should be selected to balance the resources (e.g., compute, memory, storage, etc.) needed for training and the predictive power of the resultant machine learning model 1002.

The number of training passes indicates the number of training passes that the machine learning algorithm 1004 makes over the training data set 1006 during the training process. The number of training passes can be adjusted based, for example, on the size of the training data set 1006, with larger training data sets being exposed to fewer training passes in consideration of time and/or resource utilization. The effectiveness of the resultant machine learning model 1002 can be increased by multiple training passes.

Data shuffling is a training parameter designed to prevent the machine learning algorithm 1004 from reaching false optimal weights due to the order in which data contained in the training data set 1006 is processed. For example, data provided in rows and columns might be analyzed first row, second row, third row, etc., and thus an optimal weight might be obtained well before a full range of data has been considered. By data shuffling, the data contained in the training data set 1006 can be analyzed more thoroughly and mitigate bias in the resultant machine learning model 1002.

Regularization is a training parameter that helps to prevent the machine learning model 1002 from memorizing training data from the training data set 1006. In other words, the machine learning model 1002 fits the training data set 1006, but the predictive performance of the machine learning model 1002 is not acceptable. Regularization helps the machine learning system 1000 avoid this overfitting/memorization problem by adjusting extreme weight values of the features 1008. For example, a feature that has a small weight value relative to the weight values of the other features in the training data set 1006 can be adjusted to zero.

The machine learning system 1000 can determine model accuracy after training by using one or more evaluation data sets 1010 containing the same features 1008′ as the features 1008 in the training data set 1006. This also prevents the machine learning model 1002 from simply memorizing the data contained in the training data set 1006. The number of evaluation passes made by the machine learning system 1000 can be regulated by a target model accuracy that, when reached, ends the evaluation process and the machine learning model 1002 is considered ready for deployment.

After deployment, the machine learning model 1002 can perform a prediction operation (“prediction”) 1014 with an input data set 1012 having the same features 1008″ as the features 1008 in the training data set 1006 and the features 1008′ of the evaluation data set 1010. The results of the prediction 1014 are included in an output data set 1016 consisting of predicted data. The machine learning model 1002 can perform other operations, such as regression, classification, and others. As such, the example illustrated in FIG. 10 should not be construed as being limiting in any way.

Based on the foregoing, it should be appreciated that aspects of a photograph composition service have been disclosed herein. Although the subject matter presented herein has been described in language specific to computer structural features, methodological and transformative acts, specific computing machinery, and computer-readable media, it is to be understood that the concepts and technologies disclosed herein are not necessarily limited to the specific features, acts, or media described herein. Rather, the specific features, acts and mediums are disclosed as example forms of implementing the concepts and technologies disclosed herein.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

1. A method comprising:
creating, by a requester device comprising a processor, on behalf of a requester user, a request for a photograph to be captured by a provider user via a provider device comprising a camera component, wherein the request specifies a composition template to be used by the provider user to capture the photograph, and wherein the request further specifies an offer to the provider user in compensation for capturing the photograph;
providing, by the requester device, the request to the provider device;
determining, by the requester device, if the offer was accepted;
in response to determining that the offer was accepted, notifying, by the requester device, the requester user that the offer was accepted;
receiving, by the requester device, the photograph; and
fulfilling, by the requester device, the offer to the provider user in compensation for the provider user capturing the photograph.

2. The method of claim 1, wherein the request specifies a plurality of parameters comprising a location parameter and the composition template.

3. The method of claim 2, wherein the composition template comprises a pre-built composition template or a custom composition template created by the requester user.

4. The method of claim 2, wherein the location parameter comprises a current location of the requester device or a custom location.

5. The method of claim 2, wherein the location parameter comprises a photograph opportunity location.

6. The method of claim 1, wherein providing, by the requester device, the request to the provider device comprises sending, by the requester device, the request to the provider device.

7. The method of claim 1, wherein providing, by the requester device, the request to the provider device comprises sending, by the requester device, the request to a marketplace through which the provider user can accept the offer.

8. The method of claim 1, wherein fulfilling, by the requester device, the offer to the provider user in compensation for the provider user capturing the photograph comprises initiating, by the requester device, monetary payment to be sent to an account associated the provider user.

9. A computer-readable storage medium comprising computer-executable instructions that, when executed by a processor of a requester device, cause the processor to perform operations comprising:
creating, on behalf of a requester user, a request for a photograph to be captured by a provider user via a provider device comprising a camera component, wherein the request specifies a composition template to be used by the provider user to capture the photograph, and wherein the request further specifies an offer to the provider user in compensation for capturing the photograph;
providing the request to the provider device;
determining if the offer was accepted;
in response to determining that the offer was accepted, notifying the requester user that the offer was accepted;
receiving the photograph; and
fulfilling the offer to the provider user in compensation for the provider user capturing the photograph.

10. The computer-readable storage medium of claim 9, wherein the request specifies a plurality of parameters comprising a location parameter and the composition template.

11. The computer-readable storage medium of claim 10, wherein the composition template comprises a pre-built composition template or a custom composition template created by the requester user.

12. The computer-readable storage medium of claim 10, wherein the location parameter comprises a current location of the requester device or a custom location.

13. The computer-readable storage medium of claim 10, wherein the location parameter comprises a photograph opportunity location.

14. The computer-readable storage medium of claim 9, wherein providing the request to the provider device comprises sending the request to the provider device.

15. The computer-readable storage medium of claim 9, wherein providing the request to the provider device comprises sending the request to a marketplace through which the provider user can accept the offer.

16. The computer-readable storage medium of claim 9, wherein fulfilling the offer to the provider user in compensation for the provider user capturing the photograph comprises initiating monetary payment to be sent to an account associated the provider user.

17. A requester device comprising:
a processor; and
a memory comprising computer-executable instructions that, when executed by the processor, cause the processor to perform operations comprising
creating, on behalf of a requester user, a request for a photograph to be captured by a provider user via a provider device comprising a camera component, wherein the request specifies a composition template to be used by the provider user to capture the photograph, and wherein the request further specifies an offer to the provider user in compensation for capturing the photograph,
providing the request to the provider device,
determining if the offer was accepted,
in response to determining that the offer was accepted, notifying the requester user that the offer was accepted,
receiving the photograph, and
fulfilling the offer to the provider user in compensation for the provider user capturing the photograph.

18. The requester device of claim 17, wherein the request specifies a plurality of parameters comprising a location parameter and the composition template.

19. The requester device of claim 17, wherein providing the request to the provider device comprises sending the request to the provider device or sending the request to a marketplace through which the provider user can accept the offer.

20. The requester device of claim 17, wherein fulfilling the offer to the provider user in compensation for the provider user capturing the photograph comprises initiating monetary payment to be sent to an account associated the provider user.
